(19) United States
(12) Patent Application Publication
(10) Pub. No.: US 2026/0312641 A1
(43) Pub. Date: Oct. 8, 2026

(54) BEAMFORMED TRANSMISSION OF AN INFORMATION CHANNEL

(71) Applicant: Telefonaktiebolaget LM Ericsson (publ), Stockholm (SE)

(72) Inventors: Ping WU, Stockholm (SE); Xianyun LUO, Solna (SE)

(73) Assignee: Telefonaktiebolaget LM Ericsson (publ), Stockholm (SE)

(21) Appl. No.: 19/481,746

(22) PCT Filed: May 12, 2023
(86) PCT No.: PCT/SE2023/050471

§ 371 Date: Nov. 5, 2025

(51) Int. Cl. H04B 7/06; H04W 72/23

(52) U.S. Cl. CPC H04B 7/0617; H04W 72/23

(57) ABSTRACT

There is provided techniques for beamformed transmission of an information channel with dynamically changed beamforming weights. Amplitude scaling factors and phase offset scaling factors for scaling the beamforming weights during transmission of the information channel are obtained. Beamformed transmissions of the information channel is performed whilst the scaling factors are applied to scale the beamforming weights to dynamically change the beamforming weights. The amplitude scaling factors and the phase offset scaling factors are, according to a pattern, cycled through during S>1 transmissions of the information channel. According to the pattern, in frequency domain, for one and the same symbol, different amplitude scaling factors and different phase offset scaling factors are applied for at least two different groups of resource blocks, and, in time domain, different amplitude scaling factors and different phase offset scaling factors are applied for different transmissions of the information channel.

### TECHNICAL FIELD

Embodiments presented herein relate to a method, a network node, a computer program, and a computer program product for beamformed transmission of an information channel with dynamically changed beamforming weights.

### BACKGROUND

In general terms, in communication systems such as Long-Term Evolution (LTE) and New Radio (NR), also referred to as fourth generation (4G) and fifth generation (5G) telecommunication systems respectively, but also other wireless communication systems, information is sent over different types of information channels. Information channels could be specified for either downlink, carrying information from the network-side to the user-side, or uplink, carrying information from the user-side to the network-side. Such information channels could be used for broadcast, such as system information, common reference signals and common control signaling, as well as for user-specific information, such as user-specific control information and user data. A synchronization signal block (SSB) will hereinafter be used as an illustrative example. An SSB can be regarded as an information channel (or part thereof) which carries control information in the downlink. One use of SSBs is beam management.

In FIG. 1 is illustrated an example of an SSB 10. The SSB extends over four orthogonal frequency-division multiplexing (OFDM) symbols in the time domain and over 240 subcarriers (corresponding to 20 resource blocks with 12 subcarriers per resource block-) in frequency. In turn, the SSB comprises a primary synchronization signal (PSS) in the first OFDM symbol (l=0), a physical broadcast channel (PBCH) in the second OFDM symbol (l=1), a PBCH and a second synchronization signal (SSS) in the third OFDM symbol (l=2), and a PBCH in the fourth OFDM symbol (l=3). In turn, each of the PBCHs comprises demodulation reference signals (DMRSs). Each DMRS of the PBCH occupies 3 resource elements in each resource block, which means 60 resource elements each in the second and fourth symbol (l=1 and l=3), and 12+12 resource elements in the third symbol (l=2).

When a network node transmits one and the same SSB without any transmit diversity, the channel state information (CSI) reports with received power, such as reference signal received power (RSRP) as sent by user equipment having measured on the SSB will fluctuate over time since the radio propagation channel over which the SSB is transmitted also fluctuates. Since the SSB is used for mobility, this could lead to frequent handovers, cell reselection, and even radio link failure, for the user equipment.

In NR, beam management with multiple different SSBs could be used to mitigate the effects of fluctuating radio channel quality. The user equipment could then select the best SSB and thereby the reported RSRP will be more stable over time.

However, using multiple different SSBs implies an overhead increase in time-frequency resources. This is since different common beamforming weights (i.e., beamforming weights used for information channels that are common for multiple, or even all, user equipment) need to be applied separately. Increasing the number of time-frequency resources for the SSB implies less time-frequency resources for the rest of the information channels. Thereby, the overall system throughput might be impacted.

Further, even in case multiple SSBs are transmitted, fluctuations might still persist over time for a specific SSB. Thus, although the issue might be mitigated to some extent, it will still continue to exist. Hence, for the same reasons, the issue of fluctuations will be present also for other information channels than where the SSB is transmitted. That is, other information channels might also suffer from such fluctuations.

In “Coverage Evaluation for 5G Reduced Capability New Radio (NR-RedCap)” by Saeedeh Moloudi, et al, IEEE Access (Volume: 9), Pages: 45055-45067, 15 Mar. 2021, DOI: 10.1109/ACCESS.2021.3066036, is provided an evaluation of coverage of reduced capability NR devices for different physical channels and initial access messages to identify the channels/messages that are potentially coverage limiting for RedCap user equipment. It is noted that one drawback of complexity reduction in terms of device bandwidth reduction or number of receive/transmit antenna reduction for RedCap user equipment is coverage loss which varies for different physical channels. To compensate for the coverage loss, different coverage-recovery solutions can be considered depending on the coverage-limiting channels and the level of the needed coverage recovery. However, the issues noted above still persist.

### SUMMARY

An object of embodiments herein is to address the above issues.

A particular object is to provide beamformed transmission of an information channel that does not suffer from the above issues.

A particular object is to enable a reduction in fluctuations in measurements made on information channels carrying common reference signals.

According to a first aspect there is presented a method for beamformed transmission of an information channel with dynamically changed beamforming weights. The method is performed by a network node. The method comprises obtaining amplitude scaling factors and phase offset scaling factors for scaling the beamforming weights during transmission of the information channel. The method comprises performing beamformed transmissions of the information channel whilst applying the scaling factors to scale the beamforming weights to dynamically change the beamforming weights. The amplitude scaling factors and the phase offset scaling factors are, according to a pattern, cycled through during S>1 transmissions of the information channel. According to the pattern, in frequency domain, for one and the same symbol, different amplitude scaling factors and different phase offset scaling factors are applied for at least two different groups of resource blocks. According to the pattern, in time domain, different amplitude scaling factors and different phase offset scaling factors are applied for different transmissions of the information channel.

According to a second aspect there is presented a network node for beamformed transmission of an information channel with dynamically changed beamforming weights. The network node comprises processing circuitry. The processing circuitry is configured to cause the network node to obtain amplitude scaling factors and phase offset scaling factors for scaling the beamforming weights during transmission of the information channel. The processing circuitry is configured to cause the network node to perform beamformed transmissions of the information channel whilst applying the scaling factors to scale the beamforming weights to dynamically change the beamforming weights. The amplitude scaling factors and the phase offset scaling factors are, according to a pattern, cycled through during S>1 transmissions of the information channel. According to the pattern, in frequency domain, for one and the same symbol, different amplitude scaling factors and different phase offset scaling factors are applied for at least two different groups of resource blocks. According to the pattern, in time domain, different amplitude scaling factors and different phase offset scaling factors are applied for different transmissions of the information channel.

According to a third aspect there is presented a network node for beamformed transmission of an information channel with dynamically changed beamforming weights. The network node comprises an obtain module configured to obtain amplitude scaling factors and phase offset scaling factors for scaling the beamforming weights during transmission of the information channel. The network node comprises a transmit module configured to perform beamformed transmissions of the information channel whilst applying the scaling factors to scale the beamforming weights to dynamically change the beamforming weights. The amplitude scaling factors and the phase offset scaling factors are, according to a pattern, cycled through during S>1 transmissions of the information channel. According to the pattern, in frequency domain, for one and the same symbol, different amplitude scaling factors and different phase offset scaling factors are applied for at least two different groups of resource blocks. According to the pattern, in time domain, different amplitude scaling factors and different phase offset scaling factors are applied for different transmissions of the information channel.

According to a fourth aspect there is presented a computer program for beamformed transmission of an information channel with dynamically changed beamforming weights. The computer program comprises computer code which, when run on processing circuitry of a network node, causes the network node to perform actions. One action comprises the network node to obtain amplitude scaling factors and phase offset scaling factors for scaling the beamforming weights during transmission of the information channel. One action comprises the network node to perform beamformed transmissions of the information channel whilst applying the scaling factors to scale the beamforming weights to dynamically change the beamforming weights. The amplitude scaling factors and the phase offset scaling factors are, according to a pattern, cycled through during S>1 transmissions of the information channel. According to the pattern, in frequency domain, for one and the same symbol, different amplitude scaling factors and different phase offset scaling factors are applied for at least two different groups of resource blocks. According to the pattern, in time domain, different amplitude scaling factors and different phase offset scaling factors are applied for different transmissions of the information channel.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects address the above issues.

Advantageously, these aspects enable user equipment receiving the beamformed transmissions of the information channel to experience a more stable channel quality.

Advantageously, in turn, these aspects thereby improve the network quality and performance in terms of handover, cell re-selection, etc., depending on the type of information channel.

Advantageously, in turn, these aspects thereby allow for saved power at the user equipment by reducing unnecessary frequent cell reselections, etc.

In view of the aforementioned publication “Coverage Evaluation for 5G Reduced Capability New Radio (NR-RedCap)”, the herein proposed beamformed transmission is more robust in strong fading propagation environments and yield higher beamforming gain in weak fading environments. This is achieved by dynamically changing the beamforming weights according to embodiments as herein disclosed.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 schematically illustrates an SSB according to an example.

FIG. 2 is a schematic diagram illustrating a communications network according to embodiments;

FIG. 3 is a flowchart of methods according to embodiments;

FIG. 4 schematically illustrates timelines with different restart durations according to embodiments;

FIG. 5 schematically illustrates an embodiment of changing amplitude scaling factors;

FIG. 6 schematically illustrates an embodiment of changing phase offset scaling factors;

FIG. 7 schematically illustrates an embodiment of a set of subcarriers for one sample index;

FIG. 8 is a flowchart of a method according to an embodiment;

FIG. 9 is a schematic diagram showing functional units of a network node according to an embodiment;

FIG. 10 is a schematic diagram showing functional modules of a network node according to an embodiment; and

FIG. 11 shows one example of a computer program product comprising computer readable storage medium according to an embodiment.

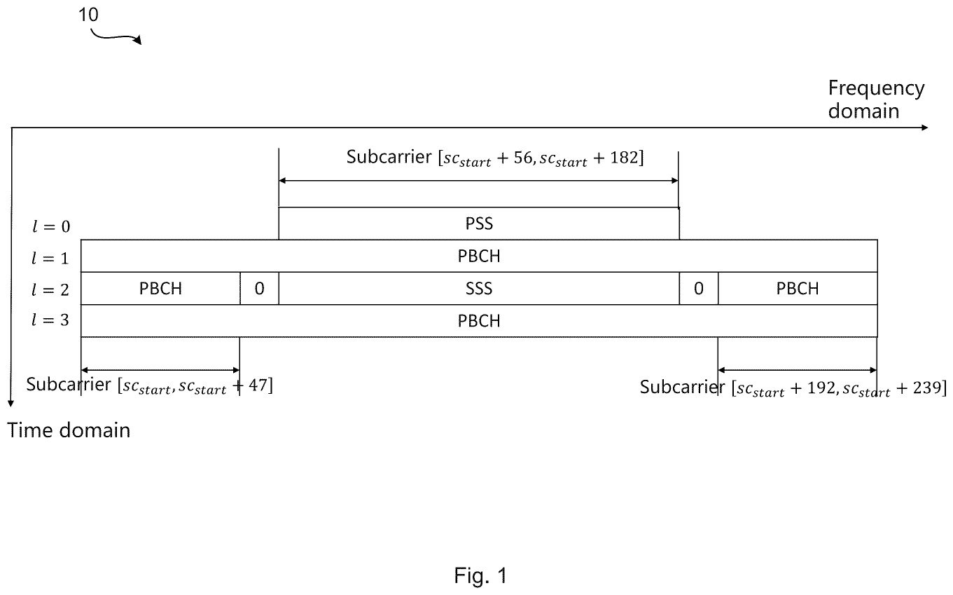

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

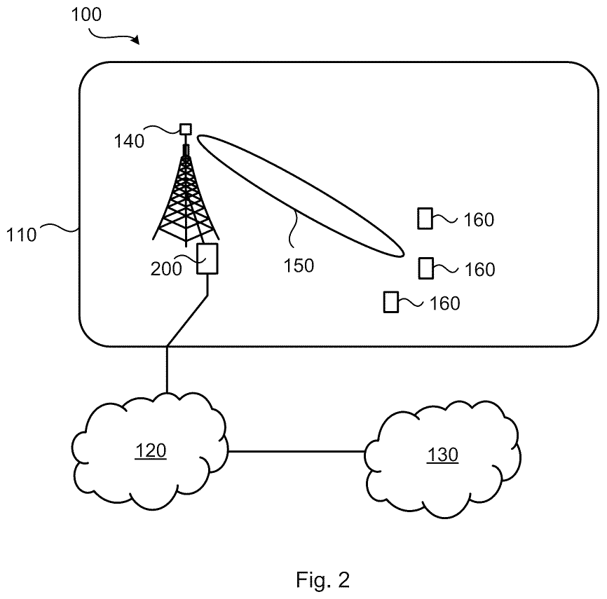

FIG. 2 is a schematic diagram illustrating a communication network 100 where embodiments presented herein can be applied. The communication network 100 could be a third generation (3G) telecommunications network, a fourth generation (4G) telecommunications network, a fifth (5G) telecommunications network, a sixth (6G) telecommunications network, and support any 3rd Generation Partnership Project (3GPP) telecommunications standard. The communication network 100 comprises a transmission and reception point 140 configured to provide network access to user equipment 160 in an (radio) access network 110 in beams, as represented by beam 150. The access network 110 is operatively connected to a core network 120. The core network 120 is in turn operatively connected to a service network 130, such as the Internet. The user equipment 160 is thereby, via the transmission and reception point 140, enabled to access services of, and exchange data with, the service network 130. Operation of the transmission and reception point 140 is controlled by a network node 200. The network node 200 might be part of, collocated with, or integrated with the transmission and reception point 140. Examples of network nodes 200 are (radio) access network nodes, radio base stations, base transceiver stations, Node Bs (NBs), evolved Node Bs (eNBs), gNBs, access points, access nodes, and integrated access and backhaul nodes. Examples of user equipment 160 are wireless devices, mobile stations, mobile phones, handsets, wireless local loop phones, smartphones, laptop computers, tablet computers, network equipped sensors, network equipped vehicles, and so-called Internet of Things devices.

The embodiments disclosed herein relate to techniques for beamformed transmission of an information channel with dynamically changed beamforming weights. In order to obtain such techniques, there is provided a network node 200, a method performed by the network node 200, a computer program product comprising code, for example in the form of a computer program, that when run on a network node 200, causes the network node 200 to perform the method.

In general terms, the herein disclosed embodiments are based on dynamically changing the common beamforming weights for one or more information channels. The dynamic change is affected in both frequency domain and time domain and in terms of both amplitude and phase changing.

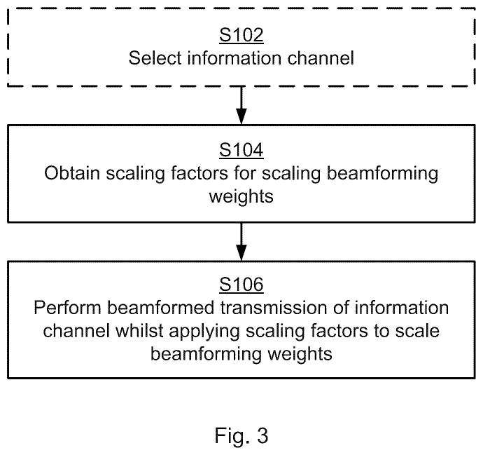

FIG. 3 is a flowchart illustrating embodiments of methods for beamformed transmission of an information channel with dynamically changed beamforming weights. Different examples of information channels will be disclosed below. The methods are performed by the network node 200. The methods are advantageously provided as computer programs 1120.
S104: The network node 200 obtains amplitude scaling factors and phase offset scaling factors for scaling the beamforming weights during transmission of the information channel. How the amplitude scaling factors and the phase offset scaling factors can be obtained, as well as properties of the amplitude scaling factors and the phase offset scaling factors, will be disclosed below.
S106: The network node 200 performs beamformed transmissions of the information channel whilst applying the scaling factors to scale the beamforming weights to dynamically change the beamforming weights. How the scaling factors are applied to scale the beamforming weights will be disclosed below.

The amplitude scaling factors and the phase offset scaling factors are, according to a pattern, cycled through during S>1 transmissions of the information channel. According to the pattern, in frequency domain, for one and the same symbol, different amplitude scaling factors and different phase offset scaling factors are applied for at least two different groups of resource blocks. Further, according to the pattern, in time domain, different amplitude scaling factors and different phase offset scaling factors are applied for different transmissions of the information channel.

In this way, dynamically changing common beamforming weights can be used for a specific information channel.

In some variations, according to the pattern, in frequency domain, for one and the same symbol, different amplitude scaling factors and different phase offset scaling factors are applied within a group of resource blocks. This is another one way in which dynamically changing common beamforming weights can be used for a specific information channel.

In some variations, according to the pattern, different amplitude scaling factors and different phase offset scaling factors are not applied in frequency domain for one and the same symbol. This still represents one way in which dynamically changing common beamforming weights can be used for a specific information channel since according to the pattern, in time domain, different amplitude scaling factors and different phase offset scaling factors are still applied for different transmissions of the information channel.

Embodiments relating to further details of beamformed transmission of an information channel with dynamically changed beamforming weights as performed by the network node 200 will now be disclosed with continued reference to FIG. 3.

Aspects of selecting the information channel, and of defining the number of samples of each restart duration will be disclosed next.

In general terms, since the beamformed transmission can be applied to different types of information channels, a selection could be made regarding which information channel the beamformed transmission with dynamically changing common beamforming weights is to be applied to. Hence, in some embodiments, the network node 200 is configured to perform (optional) step S102.
S102: The network node 200 selects the information channel from a set of candidate information channels.

In other embodiments, the beamformed transmission with dynamically changing common beamforming weights is applied to one or more predetermined information channels, and the selection in S102 can therefore be regarded as either explicit or implicit.

In some non-limiting examples, the information channel is any, or any combination, of: a channel on which a PSS is transmitted, a channel on which a SSS is transmitted, a PBCH, a channel on which an SSB is transmitted, a channel on which a CSI-RS or a TRS is transmitted, a PDCCH, a PDSCH.

In general terms, S can be regarded as a unit for the number of samples that are affected, but does not represent the total time duration of the beamformed transmission during which the beamforming weights are dynamically changing. The time interval between consecutive restarts is referred to as the restart duration. The number of changed samples of the restart duration is generally defined by the value of S in the time domain. This means that the change pattern, according to which the common beamforming weights are dynamically changed, will restart every S samples.

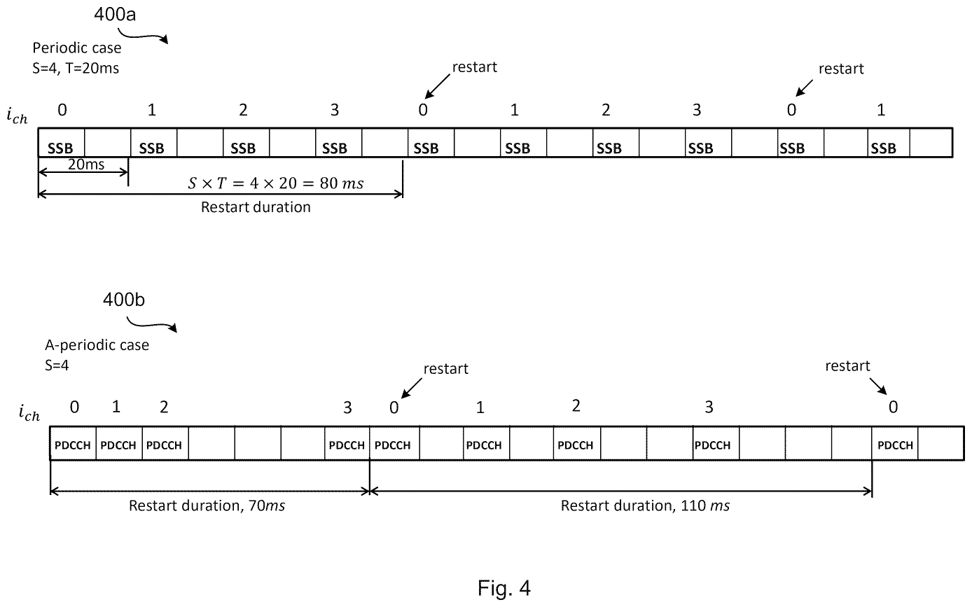

If the transmission periodicity of the information channel is T, the time interval between consecutive restarts (i.e., the restart duration) will be S·T. Otherwise, the restart duration depends on the interval among the S samples. The sample index of the information channel during each restart duration is denoted i_{ch}, where i_{ch}∈[0, . . . , S-1]. Intermediate reference is here made to FIG. 4 which illustrates a first timeline 400a with restart duration for an information channel with a transmission periodicity T, as well as a second timeline 400b with restart duration for an a-periodic information channel. For both examples, S=4. That is, the periodicity of the change pattern is four and thus the beamforming weights are repeated for every fourth transmission of the information channel. According to the timeline 400a, the information channel is a channel on which an SSB is periodically transmitted every 20 ms. According to the timeline 400b, the information channel is PDCCH, which is an a-periodic channel, where the restart duration thus varies over time.

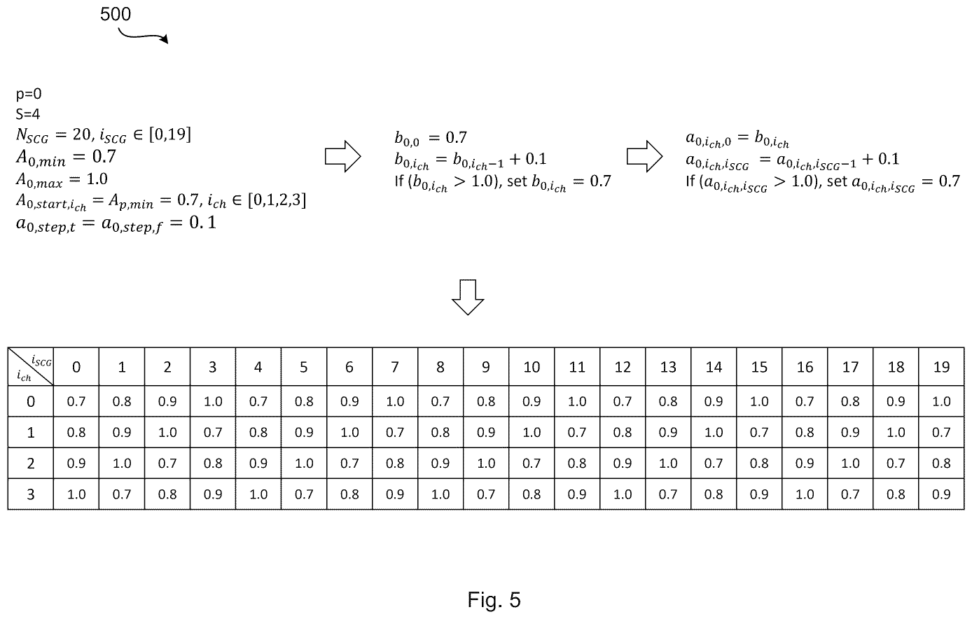

Aspects of defining the amplitude changing range and step-size will be disclosed next with intermediate reference to FIG. 5. In some embodiments, the amplitude scaling factors comprise amplitude scaling factors ranging from a minimum amplitude scaling factor to a maximum amplitude scaling factor. In some embodiments, the beamformed transmissions of the information channel is performed over ports, and there is one set of the amplitude scaling factors per port. In further detail, the normalized amplitude changing range for antenna port p can be defined as [A_{p,min}, A_{p,max}]. In some examples, the amplitude is linear changing from A_{p,min} to A_{p,max} during each restart duration. Hence, in some embodiments, according to the pattern, the amplitude scaling factors are defined by a ramp function that increases linearly and equally from the minimum amplitude scaling factor to the maximum amplitude scaling factor over the S transmissions of the information channel. However, in other examples, the amplitude is dynamically changed from A_{p,min} to A_{p,max} according to some other (non-linear) function. In this respect, that the amplitude is dynamically changed from A_{p,min} to A_{p,max} does not necessarily imply that A_{p,min} is applied to the first sample during each restart duration and that A_{p,max} is applied to the last sample of each restart duration. Thus, as an example, the ramp function can be applied to start either from the first sample and progress to the last sample or start from the last sample and progress to the first sample of each restart duration. In general terms, the range of A_{p,min} and A_{p,max} belongs to the interval [0,1]. That is, the minimum amplitude scaling factor and the maximum amplitude scaling factor each takes a value in the range [0, 1], preferably in the range [0.7, 1]. In case A_{p,min}=A_{p,max}=0, antenna port p will be muted. Conversely, in case A_{p,min}=A_{p,max}=1, antenna port p will always be transmitted with full power (and hence will not be subject to dynamical scaling). The granularity, or step-size, of the changing is denoted a_{p,step,t} in the time domain and a_{p,step,f} in the frequency domain. The start amplitude of the sample index i_{ch} is defined as A_{p,start,i}_{_{ch}} ∈[A_{p,min}, A_{p,max}], which could be same or different for different sample indices. In FIG. 5 is illustrated a table 500 with an example of how the amplitude scaling factors change over sample index i_{ch} and subcarrier group i_{SCG} (where each subcarrier group corresponds to one group of resource blocks), with numerical values as presented in the figure. Hence, the amplitude scaling factors change over time (sample index) and frequency (subcarrier group) in the range [0.7, 1] with a step of 0.1.

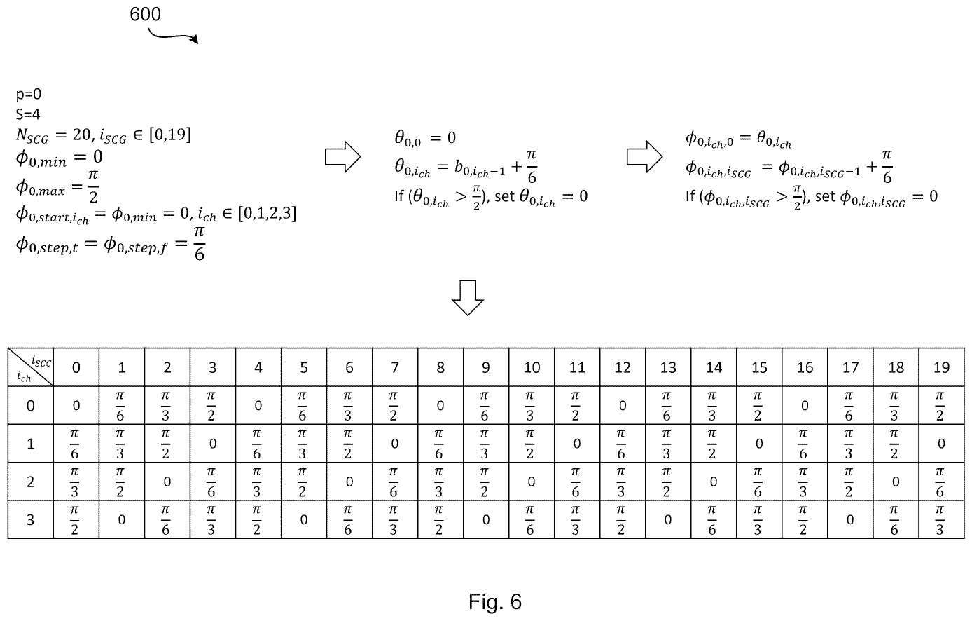

Aspects of defining the phase offset changing range and steps will be disclosed next with intermediate reference to FIG. 6.

In some embodiments, the phase offset scaling factors comprise phase offset scaling factors ranging from a minimum phase offset scaling factor to a maximum phase offset scaling factor. In some embodiments, the beamformed transmissions of the information channel is performed over ports, where there is one set of the phase offset scaling factors per port. In further detail, the phase offset changing range for antenna port p can be defined as [φ_{p,min}, φ_{p,max}]. In some examples, the phase offset is linear changing from φ_{p,min} to φ_{p,max} during each restart duration. Hence, in some embodiments, according to the pattern, the phase offset scaling factors are defined by a ramp function that increases linearly and equally from the minimum phase offset scaling factor to the maximum phase offset scaling factor. In this respect, that the phase offset is dynamically changed from φ_{p,min} to φ_{p,max} does not necessarily imply that φ_{p,min} is applied to the first sample during each restart duration and that φ_{p,max} is applied to the last sample of each restart duration. Thus, as an example, the ramp function can be applied to start either from the first sample and progress to the last sample or start from the last sample and progress to the first sample of each restart duration. In general terms, the values of φ_{p,min}, φ_{p,max}, φ_{p,step,t} and φ_{p,step,f} are confined within a range that has a maximum length of 2π. In particular, in some embodiments, the minimum phase offset scaling factor and the maximum phase offset scaling factor each takes a value in the range [−π+δ, π+δ), preferably in the range [0+δ, π/2+δ), where δ∈[0, π]. The granularity, or step-size, of the phase offset change is denoted φ_{p,step,t} in the time domain and φ_{p,step,f} in the frequency domain. The start amplitude of the sample index i_{ch} is defined as φ_{p,start,i}_{_{ch}}∈[φ_{p,min}, φ_{p,max}], which could be same or different for different sample indices. In FIG. 6 is illustrated a table 600 with an example of how the phase offset scaling factors change over sample index i_{ch} and subcarrier group i_{SCG} (where each subcarrier group corresponds to one group of resource blocks), with numerical values as presented in the figure. Hence, the phase offset scaling factors change over time (sample index) and frequency (subcarrier group) in the range [0, π/2] with a step of π/6.

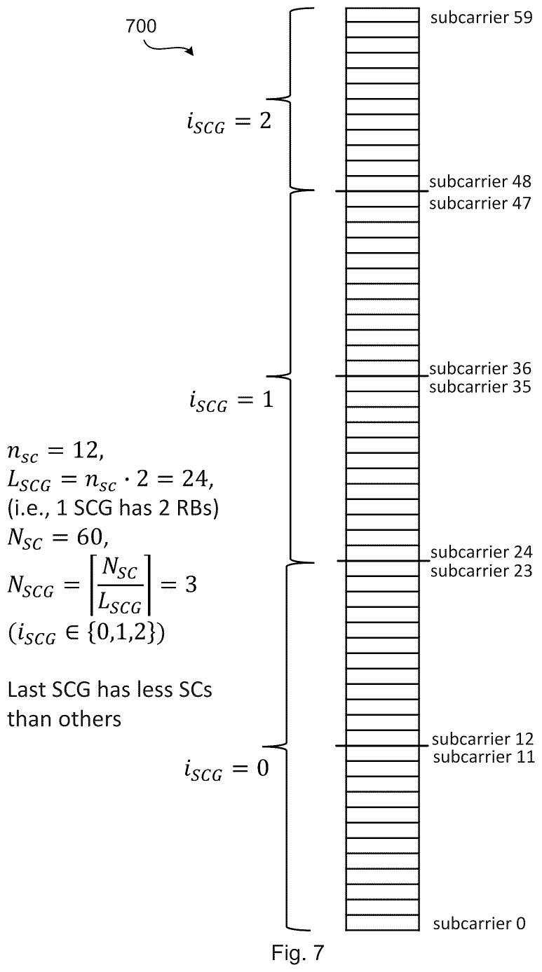

Aspects of defining the frequency domain dimension will be disclosed next with intermediate reference to FIG. 7.

In some embodiments, each of the at least two different groups of resource blocks is composed of a respective set of L_{SCG} adjacent subcarriers, where L_{SCG}∈[n_{sc}, 273·n_{sc}], where n_{sc} represents number of subcarriers per physical resource block. In some examples, n_{sc}=12. In further detail, assume that the number of subcarriers of the information channel is N_{sc}∈[n_{sc}, 273·n_{sc}]. The changing granularity in frequency domain, above defined as a group of resource blocks, can then be referred to as one subcarrier group, where the size of each group of resource blocks, or subcarrier group, is L_{SCG}, as defined above. The total number of groups of resource blocks, or subcarrier groups, can then be expressed as

$${N}_{S C G} = ⌈ \frac{{N}_{s c}}{{L}_{S C G}} ⌉ ,$$

with N_{SCG}∈[1,273]. An individual group of resource blocks, or subcarrier group, can then be referred to using an index i_{SCG}∈[0, N_{SCG}-1]. It is envisioned that the frequency domain changing of the beamforming weights can be disabled over time and/over frequency, e.g., if L_{SCG}≥N_{sc}, N_{SCG} will be 1, which means no changing in frequency domain of the beamforming weights. Hence, beamforming weights for some but not all resource blocks might be scaled. That is, in some embodiments, the at least two different groups of resource blocks comprise less than all resource blocks. Further, in the frequency domain, beamforming weights for different resource blocks can be scaled for different symbols. That is, in some embodiments, the at least two different groups of resource blocks comprise different resource blocks for different transmissions of the information channel. In FIG. 7 is illustrated a set of subcarriers 700 for one sample index, where 60 subcarriers have been divided into three subcarrier groups, i_{SCG}, and where thus 0≤i_{SCG}≤2. Subcarrier groups i_{SCG}=0, 1 are each composed of 24 carriers (i.e., two resource blocks each) whereas subcarrier group i_{SCG}=2 is composed of only 12 subcarriers (i.e., one resource block).

Aspects of generating common beamforming weights will be disclosed next.

In general terms, applying the scaling factors can be regarded as being an integral part of the actual generation of the beamforming weights. However, for illustrative purposes, the scaling of the beamforming weights has thus far been described as being applied to already generated beamforming weights.

Assume that the current sample index is i_{ch} and that the common beamforming weight for subcarrier group i_{SCG} is Vᵢ_{_{ch}}_{,i}_{_{SCG}}. In case the information channel has 1 layer, the dimension of Vᵢ_{_{ch}}_{,i}_{_{SCG}} is M_{BS}×1, in which M_{BS} is the number of antennas at the TRP 140 from which the beamformed transmissions of the information channel is made. Vᵢ_{_{ch}}_{,i}_{_{SCG}} can be re-written in vector for as:

$${V}_{{i}_{ch} , {i}_{SCG}} = [ \begin{matrix}{v}_{0 , {i}_{ch} , {i}_{SCG}} \\ {v}_{1 , {i}_{ch} , {i}_{SCG}} \\ … \\ {v}_{p , {i}_{ch} , {i}_{SCG}} \\ … \\ {v}_{{M}_{BS} - 1 , , {i}_{ch} , {i}_{SCG}}\end{matrix} ]$$

In some examples, the amplitude scaling factors applied to port p, for transmission i_{ch}∈{0, . . . , S-1} of the information channel and resource block group i_{SCG}, yield an amplitude a_{p,i}_{_{ch}}_{,i}_{_{SCG}} of the beamforming weights according to:

$${a}_{p , {i}_{ch} , {i}_{SCG}} = \{ \begin{matrix}{b}_{p , {i}_{ch}} & {i}_{ch} = 0 \\ {a}_{p , {i}_{ch} , {i}_{SCG} - 1} + {a}_{p , step , f} & {i}_{ch} \neq 0 \\ {A}_{p , min} & if {a}_{p , {i}_{ch} , {i}_{SCG}} > {A}_{p , max}\end{matrix} , where$$

$${b}_{p , {i}_{ch}} = \{ \begin{matrix}{A}_{p , start , {i}_{ch}} & {i}_{ch} = 0 \\ {b}_{p , {i}_{ch} - 1} + {a}_{p , step , t} & {i}_{ch} \neq 0 \\ {A}_{p , min} & if {b}_{p , {i}_{ch}} > {A}_{p , max}\end{matrix}$$

where A_{p,max} is the maximum amplitude scaling factor, and A_{p,min} is the minimum amplitude scaling factor.

According to the above example, the amplitude changing is a linear function of i_{ch} and i_{SCG}, but other linear functions as well as non-linear can also be used for this purpose.

In some examples, the phase offset scaling factors applied to port p, for transmission i_{ch}∈{0, . . . , S-1} of the information channel and resource block group i_{SCG}, Yield a phase φ_{p,i}_{_{ch}}_{,i}_{_{SCG}} of the beamforming weights according to:

$${ϕ}_{p , {i}_{ch} , {i}_{SCG}} = \{ \begin{matrix}{θ}_{p , {i}_{ch}} & {i}_{ch} = 0 \\ {ϕ}_{p , {i}_{ch} , {i}_{SCG} - 1} + {ϕ}_{p , step , f} & {i}_{ch} \neq 0 \\ {ϕ}_{p , min} & if {ϕ}_{p , {i}_{ch} , {i}_{SCG}} > {ϕ}_{p , max}\end{matrix} , where$$

$${θ}_{p , {i}_{ch}} = \{ \begin{matrix}{ϕ}_{p , start , {i}_{ch}} & {i}_{ch} = 0 \\ {θ}_{p , {i}_{ch} - 1} + {ϕ}_{p , step , t} & {i}_{ch} \neq 0 \\ {ϕ}_{p , min} & if {θ}_{p , {i}_{ch}} > {ϕ}_{p , max}\end{matrix}$$

where φ_{p,max} is the maximum phase offset scaling factor, and φ_{p,min} is the minimum phase offset scaling factor.

According to the above example, the phase offset changing is a linear function of i_{ch} and i_{SCG}, but other linear functions as well as non-linear can also be used for this purpose.

With amplitude scaling factors and phase offset scaling factors generated as above, application of the amplitude scaling factors and the phase offset scaling factors yield beamforming weights v_{p,i}_{_{ch}}_{,i}_{_{SCG}} according to:

$${v}_{p , {i}_{ch} , {i}_{SCG}} = {a}_{p , {i}_{ch} , {i}_{SCG}} {e}^{( i * {ϕ}_{p , {i}_{ch} , {i}_{SCG}} )}$$

Thus, the common beamforming weight V_{p,i}_{_{ch}}_{,i}_{_{SCG}} can be expressed as:

$${V}_{{i}_{ch} , {i}_{SCG}} = [ \begin{matrix}{a}_{0 , {i}_{ch} , {i}_{SCG}} {e}^{( i * {ϕ}_{0 , {i}_{ch} , {i}_{SCG}} )} \\ {a}_{1 , {i}_{ch} , {i}_{SCG}} {e}^{( i * {ϕ}_{1 , {i}_{ch} , {i}_{SCG}} )} \\ … \\ {a}_{p , {i}_{ch} , {i}_{SCG}} {e}^{( i * {ϕ}_{p , {i}_{ch} , {i}_{SCG}} )} \\ … \\ {a}_{{M}_{BS} - 1 , {i}_{ch} , {i}_{SCG}} {e}^{( i * {ϕ}_{{M}_{BS} - 1 , {i}_{ch} , {i}_{SCG}} )}\end{matrix} ]$$

After sample index i_{ch}=S-1, the value of i_{ch} is reset to 0.

Aspects of applying the generated common beamforming weights to the selected information channel will be disclosed next.

The common beamforming weight V_{p,i}_{_{ch}}_{,i}_{_{SCG}} is applied to the information channel for sample i_{ch}, and for all the L_{SCG} subcarriers of subcarrier group i_{SCG}. Therefore, in some embodiments, performing the beamformed transmissions of the information channel comprises applying the beamforming weights v_{p,i}_{_{ch}}_{,i}_{_{SCG}} to the information channel for sample i_{ch}, and for all L_{SCG} subcarriers of resource block group i_{SCG}.

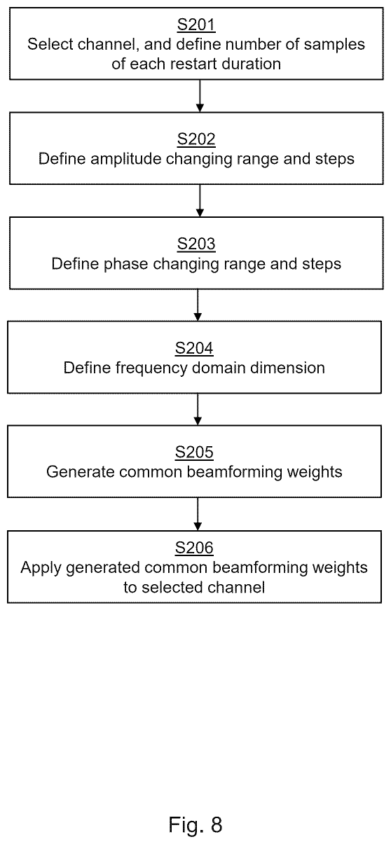

One particular embodiment for beamformed transmission of an information channel with dynamically changed beamforming weights as based on at least some of the above disclosed embodiments, aspects, and examples as performed by the network node 200 will now be disclosed with reference to the flowchart of FIG. 8.
S201: The information channel is selected, and the number of samples of each restart duration is defined.
S202: The amplitude changing range and step-size are defined.
S203: The phase offset changing range and step-size are defined.
S204: The frequency domain dimension is defined.
S205: The common beamforming weights are generated.
S206: The generated common beamforming weights are applied to the selected information channel.

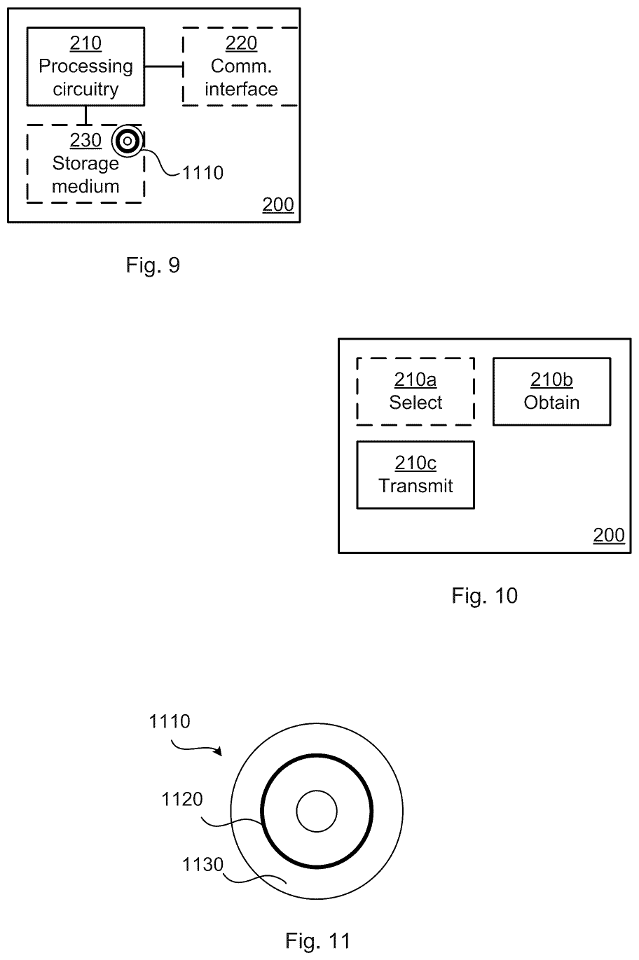

FIG. 9 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1110 (as in FIG. 11), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node 200 may further comprise a communications (comm.) interface 220 at least configured for communications with other entities, functions, nodes, and devices. As such the communications interface 220 may comprise one or more transmitters and receivers, comprising analogue and digital components. The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 10 schematically illustrates, in terms of a number of functional modules, the components of a network node 200 according to an embodiment. The network node 200 of FIG. 10 comprises a number of functional modules; an obtain module 210b configured to perform step S104, and a transmit module 210c configured to perform step S106. The network node 200 of FIG. 10 may further comprise a number of optional functional modules, such as a select module 210a configured to perform step S102. In general terms, each functional module 210a:210c may in one embodiment be implemented only in hardware and in another embodiment with the help of software, i.e., the latter embodiment having computer program instructions stored on the storage medium 230 which when run on the processing circuitry makes the network node 200 perform the corresponding steps mentioned above in conjunction with FIG. 10. It should also be mentioned that even though the modules correspond to parts of a computer program, they do not need to be separate modules therein, but the way in which they are implemented in software is dependent on the programming language used. Preferably, one or more or all functional modules 210a:210c may be implemented by the processing circuitry 210, possibly in cooperation with the communications interface 220 and/or the storage medium 230. The processing circuitry 210 may thus be configured to from the storage medium 230 fetch instructions as provided by a functional module 210a:210c and to execute these instructions, thereby performing any steps as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 9 the processing circuitry 210 may be distributed among a plurality of devices, or nodes. The same applies to the functional modules 210a:210c of FIG. 10 and the computer program 1120 of FIG. 11.

Some (radio) access network architectures define network nodes (or gNBs) comprising multiple component parts or nodes: a central unit (CU), one or more distributed units (DUs), and one or more radio units (RUs). The protocol layer stack of the network node 200 is divided between the CU, the DUs and the RUs, with one or more lower layers of the stack implemented in the RUs, and one or more higher layers of the stack implemented in the CU and/or DUs. The CU is coupled to the DUs via a fronthaul higher layer split (HLS) network; the CU/DUs are connected to the RUs via a fronthaul lower-layer split (LLS) network. The DU may be combined with the CU in some embodiments, where a combined DU/CU may be referred to as a CU or simply a baseband unit. A communication link for communication of user data messages or packets between the RU and the baseband unit, CU, or DU is referred to as a fronthaul network or interface. Messages or packets may be transmitted from the network node 200 in the downlink (i.e., from the CU to the RU) or received by the network node 200 in the uplink (i.e., from the RU to the CU).

FIG. 11 shows one example of a computer program product 1110 comprising computer readable storage medium 1130. On this computer readable storage medium 1130, a computer program 1120 can be stored, which computer program 1120 can cause the processing circuitry 210 and thereto operatively coupled entities and devices, such as the communications interface 220 and the storage medium 230, to execute methods according to embodiments described herein. The computer program 1120 and/or computer program product 1110 may thus provide means for performing any steps as herein disclosed.

In the example of FIG. 11, the computer program product 1110 is illustrated as an optical disc, such as a CD (compact disc) or a DVD (digital versatile disc) or a Blu-Ray disc. The computer program product 1110 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1120 is here schematically shown as a track on the depicted optical disk, the computer program 1120 can be stored in any way which is suitable for the computer program product 1110.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for beamformed transmission of an information channel with dynamically changed beamforming weights, wherein the method is performed by a network node, and wherein the method comprises:
obtaining amplitude scaling factors and phase offset scaling factors for scaling the beamforming weights during transmission of the information channel; and
performing beamformed transmissions of the information channel whilst applying the scaling factors to scale the beamforming weights to dynamically change the beamforming weights,
wherein the amplitude scaling factors and the phase offset scaling factors are, according to a pattern, cycled through during S>1 transmissions of the information channel,
wherein, according to the pattern, in frequency domain, for one and the same symbol, different amplitude scaling factors and different phase offset scaling factors are applied for at least two different groups of resource blocks, and
wherein, according to the pattern, in time domain, different amplitude scaling factors and different phase offset scaling factors are applied for different transmissions of the information channel.

2. The method according to claim 1, wherein the method further comprises:
selecting the information channel from a set of candidate information channels.

3. The method according to claim 1, wherein the information channel is any, or any combination of: a channel on which a PSS is transmitted, a channel on which a SSS is transmitted, a PBCH, a channel on which an SSB is transmitted, a channel on which a CSI-RS or a TRS is transmitted, a PDCCH, a PDSCH.

4. The method according to claim 1, wherein the amplitude scaling factors comprise amplitude scaling factors ranging from a minimum amplitude scaling factor to a maximum amplitude scaling factor.

5. The method according to claim 4, wherein, according to the pattern, the amplitude scaling factors are defined by a ramp function that increases linearly and equally between the minimum amplitude scaling factor and the maximum amplitude scaling factor over the S transmissions of the information channel.

6. The method according to claim 4, wherein the minimum amplitude scaling factor and the maximum amplitude scaling factor each takes a value in the range [0, 1], preferably in the range [0.7, 1].

7. The method according to claim 1, wherein the beamformed transmissions of the information channel is performed over ports, and where there is one set of the amplitude scaling factors per port.

8. The method according to claim 7, wherein the phase offset scaling factors comprise phase offset scaling factors ranging from a minimum phase offset scaling factor to a maximum phase offset scaling factor.

9. The method according to claim 8, wherein, according to the pattern, the phase offset scaling factors are defined by a ramp function that increases linearly and equally from the minimum phase offset scaling factor to the maximum phase offset scaling factor.

10. The method according to claim 8, wherein the minimum phase offset scaling factor and the maximum phase offset scaling factor each takes a value in the range [−π+δ, π+δ), preferably in the range [0+δ, π/2+δ), where δ∈[0, π].

11. The method according to claim 1, wherein the beamformed transmissions of the information channel is performed over ports, and where there is one set of the phase offset scaling factors per port.

12. The method according to claim 1, wherein each of the at least two different groups of resource blocks is composed of a respective set of L_{SCG} adjacent subcarriers, where L_{SCG}∈[n_{sc}, 273·n_{sc}], where n_{sc} represents number of subcarriers per physical resource block.

13. The method according to claim 1, wherein the at least two different groups of resource blocks comprise less than all resource blocks.

14. The method according to claim 1, wherein the at least two different groups of resource blocks comprise different resource blocks for different transmissions of the information channel.

15. The method according to claim 4, wherein the amplitude scaling factors applied to port p, for transmission i_{ch}∈{0, . . . , S-1} of the information channel and resource block group i_{SCG}, yield an amplitude a_{p,i}_{_{ch}}_{,i}_{_{SCG}} of the beamforming weights according to:
$${a}_{p , {i}_{ch} , {i}_{SCG}} = \{ \begin{matrix}{b}_{p , {i}_{ch}} & {i}_{ch} = 0 \\ {a}_{p , {i}_{ch} , {i}_{SCG} - 1} + {a}_{p , step , f} & {i}_{ch} \neq 0 \\ {A}_{p , min} & if {a}_{p , {i}_{ch} , {i}_{SCG}} > {A}_{p , max}\end{matrix} , where$$
$${b}_{p , {i}_{ch}} = \{ \begin{matrix}{A}_{p , start , {i}_{ch}} & {i}_{ch} = 0 \\ {b}_{p , {i}_{ch} - 1} + {a}_{p , step , t} & {i}_{ch} \neq 0 \\ {A}_{p , min} & if {b}_{p , {i}_{ch}} > {A}_{p , max}\end{matrix}$$
where A_{p,max} is the maximum amplitude scaling factor, and A_{p,min} is the minimum amplitude scaling factor.

16. The method according to claim 8, wherein the phase offset scaling factors applied to port p, for transmission i_{ch}∈{0, . . . , S-1} of the information channel and resource block group i_{SCG}, yield a phase φ_{p,i}_{_{ch}}_{,i}_{_{SCG}} of the beamforming weights according to:
$${ϕ}_{p , {i}_{ch} , {i}_{SCG}} = \{ \begin{matrix}{θ}_{p , {i}_{ch}} & {i}_{ch} = 0 \\ {ϕ}_{p , {i}_{ch} , {i}_{SCG} - 1} + {ϕ}_{p , step , f} & {i}_{ch} \neq 0 \\ {ϕ}_{p , min} & if {ϕ}_{p , {i}_{ch} , {i}_{SCG}} > {ϕ}_{p , max}\end{matrix} , where$$
$${θ}_{p , {i}_{ch}} = \{ \begin{matrix}{ϕ}_{p , start , {i}_{ch}} & {i}_{ch} = 0 \\ {θ}_{p , {i}_{ch} - 1} + {ϕ}_{p , step , t} & {i}_{ch} \neq 0 \\ {ϕ}_{p , min} & if {θ}_{p , {i}_{ch}} > {ϕ}_{p , max}\end{matrix}$$
where φ_{p,max} is the maximum phase offset scaling factor, and φ_{p,min} is the minimum phase offset scaling factor.

17. The method according to claim 15, wherein application of the amplitude scaling factors and the phase offset scaling factors yield beamforming weights v_{p,i}_{_{ch}}_{,i}_{_{SCG}} according to:
$${v}_{p , {i}_{ch} , {i}_{SCG}} = {a}_{p , {i}_{ch} , {i}_{SCG}} {e}^{( i * {ϕ}_{p , {i}_{ch} , {i}_{SCG}} )}$$

18. The method according to claim 17, wherein performing the beamformed transmissions of the information channel comprises applying the beamforming weights v_{p,i}_{_{ch}}_{,i}_{_{SCG}} to the information channel for sample i_{ch}, and for all L_{SCG} subcarriers of resource block group i_{SCG}.

19. A network node for beamformed transmission of an information channel with dynamically changed beamforming weights, the network node comprising processing circuitry, the processing circuitry being configured to cause the network node to:
obtain amplitude scaling factors and phase offset scaling factors for scaling the beamforming weights during transmission of the information channel; and
perform beamformed transmissions of the information channel whilst applying the scaling factors to scale the beamforming weights to dynamically change the beamforming weights,
wherein the amplitude scaling factors and the phase offset scaling factors are, according to a pattern, cycled through during S>1 transmissions of the information channel,
wherein, according to the pattern, in frequency domain, for one and the same symbol, different amplitude scaling factors and different phase offset scaling factors are applied for at least two different groups of resource blocks, and
wherein, according to the pattern, in time domain, different amplitude scaling factors and different phase offset scaling factors are applied for different transmissions of the information channel.

20.-21. (canceled)

22. A computer program product for beamformed transmission of an information channel with dynamically changed beamforming weights, the computer program product comprising a non-transitory computer readable medium storing computer code which, when run on processing circuitry of a network node, causes the network node to:
obtain amplitude scaling factors and phase offset scaling factors for scaling the beamforming weights during transmission of the information channel; and
perform beamformed transmissions of the information channel whilst applying the scaling factors to scale the beamforming weights to dynamically change the beamforming weights,
wherein the amplitude scaling factors and the phase offset scaling factors are, according to a pattern, cycled through during S>1 transmissions of the information channel,
wherein, according to the pattern, in frequency domain, for one and the same symbol, different amplitude scaling factors and different phase offset scaling factors are applied for at least two different groups of resource blocks, and
wherein, according to the pattern, in time domain, different amplitude scaling factors and different phase offset scaling factors are applied for different transmissions of the information channel.

23. (canceled)
